(19) United States
(12) Patent Application Publication
(10) Pub. No.: US 2010/0215865 A1
(43) Pub. Date: Aug. 26, 2010

(54) PREPARATION OF FLEXOGRAPHIC PRINTING MASTERS USING AN ADDITIVE PROCESS

(75) Inventors: Barkev KEOSHKERIAN, Thornhill (CA); Jennifer L. BELELIE, Oakville (CA); Naveen CHOPRA, Oakville (CA); Michelle N. CHRETIEN, Mississauga (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 12/393,230

(22) Filed: Feb. 26, 2009

(51) Int. Cl. B05D 3/02; B05D 5/06

(52) U.S. Cl. 427/511

(57) ABSTRACT

A method of forming a printing master on a flexographic plate by melting a radiation-curable phase change ink including at least one curable monomer, at least one phase change agent, at least one photoinitiator and an optional colorant. Multiple layers of the melted phase change ink are then deposited on the flexographic plate to form a raised pattern. Each of the deposited layers of ink are gelled before the deposition of a subsequent layer on the deposited layer. After a printing master with sufficient thickness is formed on the flexographic plate, the ink on the flexographic plate is cured.

### BACKGROUND

Flexographic printing is a method of direct rotary printing that uses a resilient relief image carrier to print articles such as cartons, bags, labels, newspapers, food or candy wrappers or books. Flexographic printing has found particular application in packaging, where it has displaced rotogravure and offset lithography printing techniques in many cases. Flexographic plates can be prepared from a printing plate precursor having a layer consisting of a photo-polymerizable composition, which generally comprises an elastomeric binder, at least one monomer and a photo-initiator. Early patents on flexographic printing plates include U.S. Pat. No. 3,960,572, U.S. Pat. No. 3,951,657, U.S. Pat. No. 4,323,637 and U.S. Pat. No. 4,427,759, the disclosure of each of which is entirely incorporated herein by reference.

Traditionally, an image to be printed is formed in a flexographic printing plate precursor material by exposing the photo-polymerizable layer of the flexographic printing plate to ultraviolet radiation with an image mask interposed between the radiation source and the printing plate precursor. The ultraviolet radiation causes polymerization to occur in the areas of the photo-polymerizable layer not shielded by the image mask. After imaging, the plates are processed with a suitable solvent to remove the photo-polymerizable composition in the unexposed areas, thereby creating a relief-based image on the printing plate. The processed plates are then mounted on a printing press, where they are used to transfer ink in the pattern formed in the printing plate to a desired printing surface.

The above process for manufacturing a flexographic printing plate was simplified by applying a layer for forming the image mask directly on the printing plate precursor. U.S. Pat. No. 6,521,390, incorporated herein by reference in its entirety, describes the “direct laser process”, wherein an IR-ablatable layer, substantially opaque to ultraviolet radiation, was laminated on the flexographic printing plate precursor and removed by an IR laser. The printing relief was produced upon exposing the image mask to ultraviolet light, and thus crosslinking photosensitive material on the printing relief. Various representations of the “direct laser process” are described in EP-A 654150, U.S. Pat. No. 5,259,311 and U.S. Pat. No. 6,880,461, the disclosure of each of which is incorporated herein by reference. Even though the above process for preparing the flexographic printing plate was simplified by incorporating an image mask forming layer into the printing plate precursor, the process remains complicated and time-consuming. Furthermore, the process is not environment-friendly due to a high waste production in removing the unexposed areas of the photo-polymerizable layer by the R laser.

U.S. Pat. No. 5,511,477, incorporated herein by reference in its entirety, discloses a method for the production of photopolymeric relief-type printing plates comprising the steps of forming a positive or negative image on a substrate by ink jet printing with a photopolymeric ink composition, optionally preheated to a temperature of about 30 to 260° C.; and of subjecting the resulting printed substrate to UV radiation, thereby curing the ink composition forming the image. Suitable substrates for this method are restricted to steel, polyester and other rigid materials, limiting the possibilities for flexographic applications. Another problem is that jetted droplets of the polymeric ink are still mobile and tend to deform, thereby preventing accurate reproduction of small dots and preventing the formation of sharp edges and hence the formation of a sharp image.

U.S. Pat. No. 6,520,084, incorporated herein by reference in its entirety, discloses a method for manufacturing a flexographic printing plate by means of multiple passes of an ink-jet unit employing two different elastomers that are deposited on a modifying surface. For jetting, the elastomers can be liquefied by heating meltable polymers to temperatures between 100 and 150° C. or by dissolving them in hazardous and toxic solvents such as toluene. The requirement of high temperatures restricts not only the choice of suitable substrates, but also limits the ink-jet printer to a “solid ink-jet” device. The toluene is allowed to evaporate between every two deposited layers, creating a hostile environment.

EP-A 1428666, incorporated herein by reference in its entirety, discloses a method for preparing a flexographic printing plate by jetting radiation curable inkjet ink on a resilient substrate. The disclosed inks do not contain any elastomers and the quality of the flexographic printing plate is inferior to conventional flexographic printing plates.

U.S. Pat. No. 7,401,552, incorporated herein by reference in its entirety, describes a method for preparing a flexographic printing plate by a) providing an ink-receiver surface; (b) jetting a curable jettable fluid on the ink-receiver surface characterized in that the curable jettable fluid comprises at least one photo-initiator, at least one monofunctional monomer, at least 5 wt % of a polyfunctional monomer or oligomer and at least 5 wt % of a plasticizer both based on the total weight of the curable jettable liquid, capable of realizing a layer after curing having an elongation at break of at least 5%, a storage modulus E′ smaller than 200 mPa at 30 Hz and a volumetric shrinkage smaller than 10%.

While the quality of articles printed using flexographic plates has improved significantly as the technology has matured, physical limitations related to the process of creating a relief image in a plate remain.

### SUMMARY

There is therefore a need for a fast, simple and environmental friendly method for manufacturing a flexographic printing plate with a high image quality, and applicable to a wide range of applications, including printing on soft and easily deformable surfaces.

The above and other issues are addressed by the present application, wherein in embodiments, the application relates to a method of forming a printing master on a flexographic plate, by first melting a radiation-curable phase change ink and depositing at least one drop of the melted ink on the flexographic plate in a pattern to form a first layer of an image. After the first layer of the ink is allowed to gel on the flexographic plate, an additional layer or additional layers are formed on top of the first layer, each successive layer being gelled prior to deposition of subsequent layers, until a printing master with sufficient thickness is formed on the flexographic plate. Only after the printing master with a sufficient thickness is formed, is the built up stack of jetted layers cured.

In embodiments, described is a method of forming a printing master on a flexographic plate, the method comprising: (a) melting a radiation-curable phase change ink comprised of at least one curable monomer, at least one phase change agent, at least one photoinitiator and an optional colorant, (b) depositing multiple layers of the melted ink at desired locations on the flexographic plate to form a raised pattern, wherein each deposited layer of ink is gelled prior to the deposition of a subsequent layer on the deposited layer, until the printing master with sufficient thickness is formed on the flexographic plate, and (c) curing the ink on the flexographic plate upon the conclusion of the depositing step.

In further embodiments, described is a method of forming a printing master on a flexographic plate, the method comprising: (a) melting a radiation-curable phase change ink comprised of at least one curable monomer, at least one gellant, at least one photoinitiator and an optional colorant, (b) depositing the melted ink on the flexographic plate in a pattern to form a layer of the pattern, (c) allowing the deposited layer of the of the ink to gel on the flexographic plate, (d) depositing the melted ink on the previous deposited layer to form an additional layer, (e) allowing the deposited additional layer to gel, (t repeating steps (d) through (e) to form further additional deposited and gelled layers, until the printing master with sufficient thickness is formed on the flexographic plate, and (g) curing the ink on the flexographic plate upon the achievement of the sufficient thickness, wherein the viscosity of the melted ink is from about 10⁰ cP to about 10⁵ cP at a temperature of from about 60° C. to about 100° C.

In further embodiments, described is a method of forming a printing master on a flexographic plate, the method comprising: (a) melting a radiation-curable phase change ink comprised of at least one curable monomer, at least one phase change agent, at least one photoinitiator and an optional colorant, (b) depositing the melted ink on the flexographic plate in a pattern to form a layer in the pattern, (c) allowing the deposited layer of the of the ink to gel on the flexographic plate, (d) depositing an additional layer of the melted ink on the previous deposited layer, (e) allowing the deposited additional layer to gel, (f) repeating steps (d) through (e) to form further additional deposited and gelled layers, until the printing master with an initial thickness is formed on the flexographic plate, (g) curing the ink on the flexographic plate to form an initial portion of the printing master, (h) depositing a post-initial curing layer of the melted ink on the initial portion of the printing master, (i) allowing the deposited post-initial curing deposited layer of the melted ink to gel on the flexographic plate, (j) depositing an additional post-initial curing layer of the melted ink on the previous deposited post-initial curing deposited layer, (k) allowing the deposited additional post-initial curing additional layer to gel, (l) repeating steps (j) through (k) to form further additional post-initial curing deposited and gelled layers, until the printing master with sufficient thickness is formed on the flexographic plate, and (m) curing the ink on the flexographic plate upon the achievement of the sufficient thickness.

### EMBODIMENTS

Described herein is a method of forming a printing master on a flexographic plate, the method comprising: (a) melting a radiation-curable phase change ink, (b) depositing multiple layers of the melted ink at desired locations on the flexographic plate to form a raised pattern, wherein each deposited layer of ink is gelled prior to the deposition of a subsequent layer on the deposited layer, until the printing master with sufficient thickness is formed on the flexographic plate, and (c) curing the ink on the flexographic plate upon the conclusion of the depositing step.

Furthermore, described herein is a method of forming a printing master on a flexographic plate, the method comprising: (a) melting a radiation-curable phase change ink comprised of at least one curable monomer, at least one gellant, at least one photoinitiator and an optional colorant, (b) depositing the melted ink on the flexographic plate in a pattern to form a layer of the pattern, (c) allowing the deposited layer of the of the ink to gel on the flexographic plate, (d) depositing the melted ink on the previous deposited layer to form an additional layer, (e) allowing the deposited additional layer to gel, (f) repeating steps (d) through (e) to form further additional deposited and gelled layers, until the printing master with sufficient thickness is formed on the flexographic plate, and (g) curing the ink on the flexographic plate upon the achievement of the sufficient thickness, wherein the viscosity of the melted ink is from about 10⁰ cP to about 10⁵ cP at a temperature of from about 60° C. to about 100° C.

Radiation curable phase change inks generally comprise at least one curable monomer, at least phase change agent, and an optional colorant. They may further comprise at least one photoinitiator that initiates polymerization of the curable monomer. Exemplary phase change inks suitable for use include those described in U.S. Pat. Nos. 7,276,614 and 7,279,587 and U.S. Patent Application Publication Nos. 2007/0120908; 2007/0120909; 2007/0120925 and 2008/0128570, the entire disclosures of which are hereby fully incorporated herein by reference. The printing processes of the present disclosure take advantage of this rapid change in the viscosity to limit lateral ink spreading along the surface of the printing plate material prior to curing.

The phrase “radiation curable” herein refers to, for example, the ability of the phase change ink to be cured by radiation so that it becomes permanently fixed to the flexographic plate. All forms of curing upon exposure to a radiation source are contemplated, including light and heat sources in the presence or absence of initiators. Exemplary radiation curing routes include, for example, curing using ultraviolet (UV) light, for example having a wavelength of about 200 to about 400 nm, or more rarely using visible light, curing using electron beam radiation, curing using thermal curing, and appropriate combinations thereof.

The curing of the curable monomer maybe a radically initiated curable monomer, cationically initiated curable monomer or a combination of a radically initiated and cationically initiated curable monomer. In embodiments, the monomer is equipped with one or more curable moieties, including, but not limited to, acrylates; methacrylates; vinyl ethers; epoxides, such as cycloaliphatic epoxides, aliphatic epoxides, and glycidyl epoxides; oxetanes; and the like. Suitable radiation, such as UV, curable monomers may include acrylated esters, acrylated polyesters, acrylated ethers, acrylated polyethers, acrylated epoxies, urethane acrylates, and pentaerythritol tetraacrylate and combinations thereof Specific examples of suitable acrylated monomers include monoacrylates, diacrylates, and polyfunctional alkoxylated or polyalkoxylated acrylic monomers comprising one or more di- or tri-acrylates and combinations thereof. Suitable monoacrylates are, for example, cyclohexyl acrylate, 2-ethoxy ethyl acrylate, 2-methoxy ethyl acrylate, 2-(2-ethoxyethoxy)ethyl acrylate, stearyl acrylate, tetrahydrofurfuryl acrylate, octyl acrylate, lauryl acrylate, behenyl acrylate, 2-phenoxy ethyl acrylate, tertiary butyl acrylate, glycidyl acrylate, isodecyl acrylate, benzyl acrylate, hexyl acrylate, isooctyl acrylate, isobornyl acrylate, butanediol monoacrylate, ethoxylated phenol monoacrylate, oxyethylated phenol acrylate, monomethoxy hexanediol acrylate, beta-carboxy ethyl acrylate, dicyclopentyl acrylate, carbonyl acrylate, octyl decyl acrylate, ethoxylated nonylphenol acrylate, hydroxyethyl acrylate, hydroxyethyl methacrylate, and the like and combinations thereof. Suitable polyfunctional acrylates are, for example: neopentyl glycol diacrylates, butanediol diacrylates, trimethylolpropane triacrylates, glyceryl triacrylates, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, polybutanediol diacrylate, polyethylene glycol diacrylate, polybutadiene diacrylate, tris(2-hydroxy ethyl)isocyanurate triacrylate, dipentaerythritol pentaacrylate, pentaerythritol tetraacrylate, and the like and combinations thereof. Advantageous properties, especially reduced skin irritancy, can be obtained when monomers are alkoxylated, such as ethoxylated or propoxylated, for example: propoxylated neopentyl glycol diacrylate, ethoxylated neopentyl glycol diacrylate, propoxylated hexanediol diacrylate. In embodiments, one suitable monomer is a propoxylated neopentyl glycol diacrylate, such as, for example, SR-9003 (Sartomer Co., Inc., Exton, Pa.). Other suitable reactive monomers are likewise commercially available from, for example, Sartomer Co., Inc., Cytec Industries., Rahn A G, and the like.

The curable monomer may be present in the ink in an amount of, for example, from about 20 to about 90% by weight of the ink, such as about 30 to about 85% by weight of the ink, or about 40 to about 80% by weight of the ink.

The radiation curable phase change inks may also include a phase change agent. The inclusion of a phase change agent in some phase change inks allows the inks to “phase change” or undergo a sharp increase in viscosity over a narrow temperature range upon heating the ink to a temperature above room temperature, and harden to a gel-like consistency, which is retained as the inks are cooled further to room temperature. For example, some phase change inks which may be suitable for use in the devices and methods of the present disclosure have a viscosity which changes by a factor of about 10⁴ to about 10⁹ over a temperature change of only about 20 to about 40° C.

The phase change agent may generally be any component that is miscible with the other components of the phase change ink and promotes the increase in viscosity of the ink as it cools from the jetting temperature to the flexographic plate temperature. Examples of classes of phase change agents include gellants and waxes.

In embodiments, the inclusion of a phase change agent in the radiation curable phase change inks may result a change in viscosity of least about 10² centipoise (cP), for example, from about 10⁰ cP to about 10⁵ cP, from about 10⁰ to about 10⁴, from about 10¹ to about 10², from about 10² cP to about 10⁵ cP and from about 10⁴ cP to about 10⁶ cP over a temperature range of, for example, in one embodiment at least about 30° C., for example, from about 40° C. to about 120° C., from about 60° C. to about 100° C. and about 70° C. to about 95° C.

In embodiments, a gellant is used as the phase change agent. The gellant compositions disclosed herein can act as an organic gellant in the ink to the viscosity of the ink within a desired temperature range. In particular, the gellant may form a semi-solid gel in the ink vehicle at temperatures below the specific temperature at which the ink is jetted.

The semi-solid gel phase is a physical gel that exists as a dynamic equilibrium comprising one or more solid gellant molecules and a liquid material that include the curable monomer and any other additional materials. The gellant materials may be suspended in the continuous phase of the ink. The semi-solid gel phase is a dynamic networked assembly of molecular components held together by non-covalent interactions such as hydrogen bonding, Van der Waals interactions, aromatic non-bonding interactions, ionic or coordination bonding, London dispersion forces, or the like, which, upon stimulation by physical forces, such as temperature, mechanical agitation, or the like, or chemical forces, such as pH, ionic strength, or the like, can undergo reversible transitions from liquid to semi-solid state at the macroscopic level. The solutions containing the gellant molecules exhibit a thermally reversible transition between the semi-solid gel state and the liquid state when the temperature is varied above or below the gel point of the solution. This reversible cycle of transitioning between semi-solid gel phase and liquid phase can be repeated many times in the solution formulation.

Any suitable gellant, may be used for the ink vehicles disclosed herein. Specifically, the gellant can be selected from materials disclosed in U.S. Pat. No. 7,279,587 and U.S. Pat. No. 7,276,614 the disclosures of which are totally incorporated herein by reference, such as a compound of the formula

R₃—X—CO—R₂—CO—NH—R₁—NH—CO—R₂′—CO—X′—R₃′,

wherein: R₁ is selected from the group consisting of an alkylene group, an arylene group, an arylalkylene group and an alkylarylene group; R₂ and R₂′ are selected from the group consisting of an alkylene group, an arylene group, an arylalkylene group and an alkylarylene group; R₃ and R₃′ are selected from the group consisting of a photoinitiating group, an alkyl group, an aryl group, an arylalkyl group and an alkylaryl group; and X and X′ is an oxygen atom or a group of the formula —NR₄—.

The alkylene group for R₁ is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may be present in the alkylene group). The alkylene group for R₁ includes from 1 carbon atom to about 12 carbon atoms. In another embodiment, the alkylene group for R₁ includes no more than about 4 carbon atoms, and in yet another embodiment no more than about 2 carbon atoms.

The arylene group for R₁ is defined as a divalent aromatic group or aryl group, including substituted and unsubstituted arylene groups, and wherein heteroatoms, such as oxygen, nitrogen, sulfur, silicon, phosphorus, boron, and the like either may be present in the arylene group. The arylene group for R₁ includes from about 5 carbon atoms to about 14 carbon atoms. In another embodiment, the arylene group for R₁ includes no more than about 10 carbon atoms, and in yet another embodiment with no more than about 6 carbon atoms.

The arylalkylene group for R₁ is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may be present in either the aryl or the alkyl portion of the arylalkylene group. The arylalkylene group for R₁ includes at least from about 6 carbon atoms, and in another embodiment with at least about 7 carbon atoms. In one embodiment, the arylalkylene group for R₁ includes no more than about 32 carbon atoms, in another embodiment with no more than about 22 carbon atoms, and in yet another embodiment with no more than about 7 carbon atoms.

The alkylarylene group for R₁ is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group. The alkylarylene group for R₁ includes at least about 6 carbon atoms, and in another embodiment with at least about 7 carbon atoms. In one embodiment, the alkylarylene group for R₁ includes no more than about 32 carbon atoms, in another embodiment with no more than about 22 carbon atoms, and in yet another embodiment with no more than about 7 carbon atom. Furthermore, the substituents on the substituted alkylene, arylene, arylalkylene, and alkylarylene groups can be halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring.

The alkylene group for R₂ and R₂′ may include a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group). The alkylene group for R₂ and R₂′ includes at least 1 carbon atom, and in one embodiment with no more than about 54 carbon atoms, and in another embodiment with no more than about 36 carbon atoms.

The arylene group for R₂ and R₂′ may include a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group. The arylene group for R₂ and R₂′ includes at least about 5 carbon atoms, and in one embodiment with no more than about 14 carbon atoms, in another embodiment with no more than about 10 carbon atoms, and in yet another embodiment with no more than about 7 carbon atoms.

The arylalkylene group for R₂ and R₂′ may include a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group. The arylalkylene group for R₂ and R₂′ includes at least about 6 carbon atoms, and in one embodiment with no more than about 32 carbon atoms, in another embodiment with no more than about 22 carbon atoms, and in yet another embodiment with no more than about 8 carbon atoms.

The alkylarylene group for R₂ and R₂′ may include a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group. The alkylarylene group for R₂ and R₂′ includes at least about 6. carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges. The substituents for the alkylene, arylene, arylalkylene, and alkylarylene groups can be (but are not limited to) halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, wherein two or more substituents can be joined together to form a ring.

The alkylarylene group for R₂ may be derived from 1-(4-(2-hydroxyethoxy)phenyl)-2-hydroxy-2-methylpropan-1-one, 1-hydroxycyclohexylphenylketone, 2-hydroxy-2-methyl-1-phenylpropan-1-one, and the like. The formulas for these compounds are described in paragraph [0073] of U.S. Patent Application Pub. No. 2008/0218570, the disclosure of which is incorporated herein by reference herein in its entirety.

The alkyl group for R₃ and R₃′ may include linear and branched, saturated and unsaturated, cyclic and acyclic, and substituted and unsubstituted alkyl groups, and wherein heteroatoms, such as oxygen, nitrogen, sulfur, silicon, phosphorus, boron, and the like either may be present in the alkyl group. The alkyl group for R₃ and R₃′ includes at least about 2 carbon atoms, in another embodiment with at least about 3 carbon atoms, and in yet another embodiment with at least about 4 carbon atoms, and in one embodiment with no more than about 100 carbon atoms, in another embodiment with no more than about 60 carbon atoms, and in yet another embodiment with no more than about 30 carbon atoms.

The alkyl group for R₃ and R₃′ may include substituted and unsubstituted aryl groups, and wherein heteroatoms, such as oxygen, nitrogen, sulfur, silicon, phosphorus, boron, and the like either may be present in the aryl group. The aryl group for R₃ includes at least about 5 carbon atoms, and in another embodiment with at least about 6 carbon atoms, and in one embodiment with no more than about 100 carbon atoms, in another embodiment with no more than about 60 carbon atoms, and in yet another embodiment with no more than about 30 carbon atoms.

The arylalkyl group for R₃ and R₃′ may include a substituted and unsubstituted arylalkyl groups, wherein the alkyl portion of the arylalkyl group can be linear or branched, saturated or unsaturated, and cyclic or acyclic, and wherein heteroatoms, such as oxygen, nitrogen, sulfur, silicon, phosphorus, boron, and the like either may be present in either the aryl or the alkyl portion of the arylalkyl group. The arylalkyl group for R₃ and R₃′ includes at least about 6 carbon atoms, and in another embodiment at least about 7 carbon atoms, and in one embodiment no more than about 100 carbon atoms, in another embodiment no more than about 60 carbon atoms, and in yet another embodiment no more than about 30 carbon atoms.

The alkylaryl group for R₃ and R₃′ may include substituted and unsubstituted alkylaryl groups, wherein the alkyl portion of the alkylaryl group can be linear or branched, saturated or unsaturated, and cyclic or acyclic, and wherein heteroatoms, such as oxygen, nitrogen, sulfur, silicon, phosphorus, boron, and the like either may be present in either the aryl or the alkyl portion of the alkylaryl group. The alkylaryl group for R₃ and R₃′ includes at least about 6 carbon atoms, and in another embodiment at least about 7 carbon atoms, and in one embodiment no more than about 100 carbon atoms, in another embodiment with no more than about 60 carbon atoms, and in yet another embodiment with no more than about 30 carbon atoms, although the number of carbon atoms can be outside of these ranges, such as tolyl or the like. The substituents on the substituted alkyl, arylalkyl, and alkylaryl groups can be halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof and the like, wherein two or more substituents can be joined together to form a ring.

The X and X′ may include an oxygen atom or a group of the formula —NR₄—, wherein R₄ is: (i) a hydrogen atom; (ii) an alkyl group, including linear and branched, saturated and unsaturated, cyclic and acyclic, and substituted and unsubstituted alkyl groups, and wherein hetero atoms either may be present in the alkyl group, in one embodiment with at least 1 carbon atom, and in one embodiment with no more than about 100 carbon atoms, in another embodiment with no more than about 60 carbon atoms, and in yet another embodiment with no more than about 30 carbon atoms, (iii) an aryl group, including substituted and unsubstituted aryl groups, and wherein heteroatoms either may be present in the aryl group, in one embodiment with at least about 5 carbon atoms, and in another embodiment with at least about 6 carbon atoms, and in one embodiment with no more than about 100 carbon atoms, in another embodiment with no more than about 60 carbon atoms, and in yet another embodiment with no more than about 30 carbon atoms, (iv) an arylalkyl group, including substituted and unsubstituted arylalkyl groups, wherein the alkyl portion of the aryalkyl group can be linear or branched, saturated or unsaturated, and cyclic or acyclic, and wherein heteroatoms either may be present in either the aryl or the alkyl portion of the arylalkyl group, in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, or (v) an alkylaryl group, including substituted and unsubstituted alkylaryl groups, wherein the alkyl portion of the alkylaryl group can be linear or branched, saturated or unsaturated, and cyclic or acyclic, and wherein heteroatoms either may be present in either the aryl or the alkyl portion of the alkylaryl group, in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, wherein the substituents on the substituted alkyl, aryl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring.

In specific embodiments, the gellant is a compound of one of the formulas described in U.S. Patent Application Pub. No. 2008/0218570, the disclosure of which is incorporated herein by reference herein in its entirety. The gellant compounds as disclosed herein can be prepared by any desired or effective method, including by not limited to the method described U.S. Patent Application Pub. No. 2008/0218570.

Furthermore, some of the curable monomers described above may also a exhibit gel-like behavior in that they undergo a relatively sharp increase in viscosity over a relatively narrow temperature range when dissolved in a liquid. One example of such a liquid monomer is a propoxylated neopentyl glycol diacrylate such as SR9003, commercially available from Sartomer Co. Inc.

The ink compositions can include a gellant in any suitable amount, such as from about 1% to about 50% by weight of the ink. In embodiments, the gellant can be present in an amount of about 2% to about 20% by weight of the ink and such as about 5% to about 15% by weight of the ink.

A curable wax may also be used as a phase change agent. The curable wax may be any wax component that is miscible with the other components and that will polymerize with the curable monomer to form a polymer. The term “wax” includes, for example, any of the various natural, modified natural, and synthetic materials commonly referred to as waxes. A wax is solid at room temperature, specifically at 25° C. and may promote an increase in viscosity of the ink as it cools from the jetting temperature.

Suitable examples of curable waxes include those waxes that include or are functionalized with curable groups. The curable groups may include, for example, acrylate, methacrylate, alkene, allylic ether, epoxide, oxetane, and the like. These waxes can be synthesized by the reaction of a wax equipped with a transformable functional group, such as carboxylic acid or hydroxyl.

Suitable examples of hydroxyl-terminated polyethylene waxes that may be functionalized with a curable group include, but are not limited to, mixtures of carbon chains with the structure CH₃—(CH₂)ₙ—CH₂OH, where n is the chain length and can be in the range of about 16 to about 50, from about 20 to 40, from about 25 to about 35 and from about 25 to about 30. Suitable examples of such waxes include, but are not limited to, the UNILIN series of materials such as UNILIN 350, UNILIN 425, UNILIN 550 and UNILIN 700 with Mn approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Exemplary Guerbet alcohols include those containing about 16 to about 36 carbons, many of which are commercially available from Jarchem Industries Inc., Newark, N.J. PRIPOL 2033 (a C-36 dimer diol mixture). These alcohols can be reacted with carboxylic acids equipped with UV curable moieties to form reactive esters. Examples of these acids include acrylic and methacrylic acids, available from Sigma-Aldrich Co.

Suitable examples of carboxylic acid-terminated polyethylene waxes that may be functionalized with a curable group include mixtures of carbon chains with the structure CH₃—(CH₂)ₙ—COOH, where n is the chain length and can be in the range of about 16 to about 50, from about 20 to 40, from about 25 to about 35 and from about 25 to about 30. Suitable examples of such waxes include, but are not limited to, the UNILIN series of materials such as UNILIN 350, UNILIN 425, UNILIN 550 and UNILIN 700 with Mn approximately equal to 375, 460, 550 and 700 g/mol, respectively. Other suitable waxes have a structure CH₃—(CH₂)ₙ—COOH, such as hexadecanoic or palmitic acid (n=14), heptadecanoic or margaric or daturic acid (n=15), octadecanoic or stearic acid (n=16), eicosanoic or arachidic acid (n=18), docosanoic or behenic acid (n=20), tetracosanoic or lignoceric acid (n=22), hexacosanoic or cerotic acid (n=24), heptacosanoic or carboceric acid (n=25), octacosanoic or montanic acid (n=26), triacontanoic or melissic acid (n=28), dotriacontanoic or lacceroic acid (n=30), tritriacontanoic or ceromelissic or psyllic acid (n=31), tetratriacontanoic or geddic acid (n=32), pentatriacontanoic or ceroplastic acid (n=33). Guerbet acids, characterized as 2,2-dialkyl ethanoic acids, are also suitable compounds. Exemplary Guerbet acids include those containing 16 to 36 carbons, many of which are commercially available from Jarchem Industries Inc., Newark, N.J. PRIPOL. 1009. These carboxylic acids can be reacted with alcohols equipped with UV curable moieties to form reactive esters. Examples of these alcohols include, but are not limited to, 2-allyloxyethanol from Sigma-Aldrich Co.; SR495B from Sartomer Company, Inc.; CD572 and SR604 from Sartomer Company, Inc.

Other suitable examples of curable waxes include, for example, AB₂ diacrylate hydrocarbon compounds that may be prepared by reacting AB₂ molecules with acryloyl halides, and then further reacting with aliphatic long-chain, mono-functional aliphatic compounds. Suitable functional groups useful as A groups in embodiments include carboxylic acid groups and the like. Suitable functional groups useful as B groups in embodiments may be hydroxyl groups, thiol groups, amine groups, amide groups, imide groups, phenol groups, and mixtures thereof Exemplary AB₂ molecules include, for example, bishydroxy alkyl carboxylic acids (AB₂ molecules in which A is carboxylic acid and B is hydroxyl), 2,2-bis(hydroxymethyl)butyric acid, N,N-bis(hydroxyethyl)glycine, 2,5-dihydroxybenzyl alcohol, 3,5-bis(4-aminophenloxy)benzoic acid, and the like.

In embodiments, the acryloyl halide may be chosen from acryloyl fluoride, acryloyl chloride, acryloyl bromide, and acryloyl iodide, and mixtures thereof. In particular embodiments, the acryloyl halide is acryloyl chloride.

Exemplary methods for making AB₂ molecules may include optionally protecting the B groups first. Methods for protecting groups such as hydroxyls will be known to those of skill in the art. An exemplary method for making AB₂ molecules such as 2,2-bis(hydroxylmethyl)proprionic acid is the use of benzaldehyde dimethyl acetal catalyzed by a sulfonic acid such as p-toluene sulfonic acid in acetone at room temperature to form benzylidene-2,2-bis(oxymethyl)proprionic acid. This protected AB₂ molecule may be subsequently coupled with an aliphatic alcohol. Suitable aliphatic alcohols include stearyl alcohol; 1-docosanol; hydroxyl-terminated polyethylene waxes such as mixtures of carbon chains with the structure CH₃—(CH₂)ₙ—CH₂OH, where n is the chain length and can be in the range of about 16 to about 50, from about 20 to 40, from about 25 to about 35 and from about 25 to about 30. Suitable examples of such waxes include, but are not limited to, the UNILIN series of materials such as UNILIN 350, UNILIN 425, UNILIN 550 and UNILIN 700 with Mn approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Exemplary Guerbet alcohols include those containing about 16 to about 36 carbons, many of which are commercially available from Jarchem Industries Inc., Newark, N.J. PRIPOL2033 (a C-36 dimer diol mixture). These alcohols can be reacted with carboxylic acids equipped with UV curable moieties to form reactive esters. Examples of these acids include acrylic and methacrylic acids, available from Sigma-Aldrich Co.

The acid group of the AB₂ monomer may be esterified by the aliphatic alcohol using p-toluenesulfonic acid in refluxing toluene. Following the reaction of the aliphatic alcohol with the protected AB₂ monomer, the protecting groups may be removed in methylene chloride using a palladium carbon catalyst under hydrogen gas. Once deprotected, the final product diacrylate aliphatic ester may be made using acryloyl chloride in methylene chloride with pyridine or triethylamine.

The curable wax can be included in the ink composition in an amount of from about 0 to about 25% by weight of the ink, such as, for example, from 1 to about 15% by weight of ink and from about 2 to about 10 by weight of the ink. In an embodiment, the curable wax can be included in the ink composition in an amount of from about 3 to about 10% by weight of the ink, such as about 4 to about 6% by weight of the ink.

The radiation curable phase change inks may also contain an optional colorant. Any desired or effective colorant can be employed in the inks, including pigment, dye, mixtures of pigment and dye, mixtures of pigments, mixtures of dyes, and the like, provided that the colorant can be dissolved or dispersed in the ink vehicle. The compositions can be used in combination with conventional ink colorant materials, such as Color Index (C.I.) Solvent Dyes, Disperse Dyes, modified Acid and Direct Dyes, Basic Dyes, Sulphur Dyes, Vat Dyes, and the like. Examples of suitable dyes include Neozapon Red 492 (BASF); Orasol Red G (Ciba); Direct Brilliant Pink B (Oriental Giant Dyes); Direct Red 3BL (Classic Dyestuffs); Supranol Brilliant Red 3BW (Bayer AG); Lemon Yellow 6G (United Chemie); Light Fast Yellow 3G (Shaanxi); Aizen Spilon Yellow C-GNH (Hodogaya Chemical); Bernachrome Yellow GD Sub (Classic Dyestuffs); Cartasol Brilliant Yellow 4GF (Clariant); Cibanon Yellow 2GN (Ciba); Orasol Black CN (Ciba); Savinyl Black RLSN (Clariant); Pyrazol Black BG (Clariant); Morfast Black 101 (Rohm & Haas); Diaazol Black RN (ICI); Orasol Blue GN (Ciba); Savinyl Blue GLS (Clariant); Luxol Fast Blue MBSN (Pylam Products); Sevron Blue 5GMF (Classic Dyestuffs); Basacid Blue 750 (BASF), Neozapon Black X51 (BASF), Classic Solvent Black 7 (Classic Dyestuffs), Sudan Blue 670 (C.I. 61554) (BASF), Sudan Yellow 146 (C.I. 12700) (BASF), Sudan Red 462 (C.I. 26050) (BASF), C.I. Disperse Yellow 238, Neptune Red Base NB543 (BASF, C.I. Solvent Red 49), Neopen Blue FF-4012 from BASF, Lampronol Black BR from ICI (C.I. Solvent Black 35), Morton Morplas Magenta 36 (C.I. Solvent Red 172), metal phthalocyanine colorants such as those disclosed in U.S. Pat. No. 6,221,137, the disclosure of which is totally incorporated herein by reference, and the like. Polymeric dyes can also be used, such as those disclosed in, for example, U.S. Pat. No. 5,621,022 and U.S. Pat. No. 5,231,135, the disclosures of each of which are herein entirely incorporated herein by reference, and commercially available from, for example, Milliken & Company as Milliken Ink Yellow 869, Milliken Ink Blue 92, Milliken Ink Red 357, Milliken Ink Yellow 1800, Milliken Ink Black 8915-67, uncut Reactant Orange X-38, uncut Reactant Blue X-17, Solvent Yellow 162, Acid Red 52, Solvent Blue 44, and uncut Reactant Violet X-80.

Pigments are also suitable colorants for the phase change inks. Examples of suitable pigments include PALIOGEN Violet 5100 (commercially available from BASF); PALIOGEN Violet 5890 (commercially available from BASF); HELIOGEN Green L8730 (commercially available from BASF); LITHOL Scarlet D3700 (commercially available from BASF); SUNFAST Blue 15:4 (commercially available from Sun Chemical); Hostaperm Blue B2G-D (commercially available from Clariant); Hostaperm Blue B4G (commercially available from Clariant); Permanent Red P-F7RK; Hostaperm Violet BL (commercially available from Clariant); LITHOL Scarlet 4440 (commercially available from BASF); Bon Red C (commercially available from Dominion Color Company); ORACET Pink RF (commercially available from Ciba); PALIOGEN Red 3871 K (commercially available from BASF); SUNFAST Blue 15:3 (commercially available from Sun Chemical); PALIOGEN Red 3340 (commercially available from BASF); SUNFAST Carbazole Violet 23 (commercially available from Sun Chemical); LITHOL Fast Scarlet L4300 (commercially available from BASF); SUNBRITE Yellow 17 (commercially available from Sun Chemical); HELIOGEN Blue L6900, L7020 (commercially available from BASF); SPECTRA Yellow 74 (commercially available from Sun Chemical); SPECTRA PAC C Orange 16 (commercially available from Sun Chemical); HELIOGEN Blue K6902, K6910 (commercially available from BASF); SUNFAST Magenta 122 (commercially available from Sun Chemical); HELIOGEN Blue D6840, D7080 (commercially available from BASF); Sudan Blue OS (commercially available from BASF); NEOPEN Blue FF4012 (commercially available from BASF); PV Fast Blue B2GO1 (commercially available from Clariant); IRGALITE Blue BCA (commercially available from Ciba); PALIOGEN Blue 6470 (commercially available from BASF); Sudan Orange G (commercially available from Aldrich), Sudan Orange 220 (commercially available from BASF); PALIOGEN Orange 3040 (BASE); PALIOGEN Yellow 152, 1560 (commercially available from BASF); LITHOL Fast Yellow 0991 K (commercially available from BASF); PALIOTOL Yellow 1840 (commercially available from BASF); NOVOPERM Yellow FGL (commercially available from Clariant); Ink Jet Yellow 4G VP2532 (commercially available from Clariant); Toner Yellow HG (commercially available from Clariant); Lumogen Yellow D0790 (commercially available from BASF); Suco-Yellow L1250 (commercially available from BASF); Suco-Yellow D1355 (commercially available from BASF); Suco Fast Yellow D1 355, D1 351 (commercially available from BASF); HOSTAPERM Pink E 02 (commercially available from Clariant); Hansa Brilliant Yellow 5GX03 (commercially available from Clariant); Permanent Yellow GRL 02 (commercially available from Clariant); Permanent Rubine L6B 05 (commercially available from Clariant); FANAL Pink D4830 (commercially available from BASF); CINQUASIA Magenta (commercially available from DU PONT); PALIOGEN Black L0084 (commercially available from BASF); Pigment Black K801 (commercially available from BASF); and carbon blacks such as REGAL 330™ (commercially available from Cabot), Nipex 150 (commercially available from Degusssa) Carbon Black 5250 and Carbon Black 5750 (commercially available from Columbia Chemical), and the like, as well as mixtures thereof.

Also suitable are the colorants disclosed in U.S. Pat. No. 6,472,523, U.S. Pat. No. 6,726,755, U.S. Pat. No. 6,476,219, U.S. Pat. No. 6,576,747, U.S. Pat. No. 6,713,614, U.S. Pat. No. 6,663,703, U.S. Pat. No. 6,755,902, U.S. Pat. No. 6,590,082, U.S. Pat. No. 6,696,552, U.S. Pat. No. 6,576,748, U.S. Pat. No. 6,646,111, U.S. Pat. No. 6,673,139, U.S. Pat. No. 6,958,406, U.S. Pat. No. 6,821,327, U.S. Pat. No. 7,053,227, U.S. Pat. No. 7,381,831 and U.S. Pat. No. 7,427,323, the disclosures of each of which are incorporated herein by reference in their entirety.

In embodiments, solvent dyes are employed. An example of a solvent dye suitable for use herein may include spirit soluble dyes because of their compatibility with the ink carriers disclosed herein. Examples of suitable spirit solvent dyes include Neozapon Red 492 (BASF); Orasol Red G (Ciba); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (Ciba); Orasol Black RLP (Ciba); Savinyl Black RLS (Clariant); Morfast Black Conc. A (Rohm and Haas); Orasol Blue GN (Ciba); Savinyl Blue GLS (Sandoz); Luxol Fast Blue MBSN (Pylam); Sevron Blue 5GMF (Classic Dyestuffs); Basacid Blue 750 (BASF), Neozapon Black X51 [C.I. Solvent Black, C.I. 12195] (BASF), Sudan Blue 670 [C.I. 61554] (BASF), Sudan Yellow 146 [C.I. 12700] (BASF), Sudan Red 462 [C.I. 260501] (BASF), mixtures thereof and the like.

The colorant may be present in the phase change ink in any desired or effective amount to obtain the desired color or hue such as, for example, from about 0 percent by weight of the ink to about 50 percent by weight of the ink, at least from about 0.2 percent by weight of the ink to about 20 percent by weight of the ink, and at least from about 0.5 percent by weight of the ink to about 10 percent by weight of the ink.

In embodiments, the radiation curable phase change inks may further comprise an initiator, such as a photoinitiator, that initiates polymerization of curable components of the ink, including the curable monomer and the optional curable wax. The initiator should be soluble in the composition. In embodiments, the initiator is an ultraviolet-activated (UV-activated) photoinitiator.

In embodiments, the initiator can be a radical initiator. Examples of radical photoinitiators include benzophenone derivatives, benzyl ketones, monomeric hydroxyl ketones, alpha.-amino ketones, acyl phosphine oxides, metallocenes, benzoin ethers, benzil ketals, alpha.-hydroxyalkylphenones, alpha.-aminoallylphenones, acylphosphine photoinitiators sold under the trade designations of IRGACURE and DAROCUR from Ciba, isopropyl thioxanthenones, and the like, and combinations thereof. Specific examples include 1-hydroxy-cyclohexylphenylketone, benzophenone, benzophenone derivatives, 2-benzyl-2-(dimethylamino)-1-(4-(4-morphorlinyl)phenyl)-1-butanone, 2-methyl-1-(4-methylthio)phenyl-2-(4-morphorlinyl)-1-propanone, diphenyl-(2,4,6-trimethylbenzoyl)phosphine oxide, phenyl bis(2,4,6-trimethylbenzoyl) phosphine oxide, benzyl-dimethylketal, isopropylthioxanthone, 2,4,6-trimethylbenzoyidipbenylphosphine oxide (available as BASF LUCIRIN TPO), 2,4,6-trimethylbenzoylethoxyphenylphosphine oxide (available as BASF LUCIRIN TPO-L), bis(2,4,6-trimethylbenzoyl)-phenyl-phosphine oxide (available as Ciba IRGACURE 819) and other acyl phosphines, 2-methyl-1-(4-methylthio)phenyl-2-(4-fluorphorlinyl)-1-propanone (available as Ciba IRGACURE 907) and 1-(4-(2-hydroxyethoxy)phenyl)-2-hydroxy-2-methylpropan-1-one (available as Ciba IRGACURE 2959), 2-benzyl2-dimethylamino 1-(4-morpholinophenyl)butanone-1 (available as Ciba IRGACURE 369), 2-hydroxy-1-(4-(4-(2-hydroxy-2-methylpropionyl)-benzyl)-phenyl)-2-methylpropan-1-one (available as Ciba IRGACURE 127), 2-dimethylamino-2-(4-methylbenzyl)-1-(4-morpholin-4-ylphenyl)-butanone (available as Ciba IRGACURE 379), titanocenes, isopropylthioxanthenones, 1-hydroxy-cyclohexylphenylketone, benzophenone, 2,4,6-trimethylbenzophenone, 4-methylbenzophenone, diphenyl-(2,4,6-trimethylbenzoyl) phosphine oxide, 2,4,6-trimethylbenzoylphenylphosphinic acid ethyl ester, oligo(2-hydroxy-2-methyl-1-(4-(1-methylvinyl)phenyl)propanone), 2-hydroxy-2-methyl-1-phenyl-1-propanone, benzyl-dimethylketal, and the like, as well as mixtures thereof In an embodiment, the ink contains an alpha-amino ketone, such as, for example, IRGACURE 379 (Ciba Specialty Chemicals), 2-hydroxy-1-(4-(4-(2-hydroxy-2-methylpropionyl)-benzyl)-phenyl)-2-methylpropan-1-one, such as, for example, IRGACURE 127 (Ciba Specialty Chemicals), bis(2,4,6-trimethylbenzoyl)-phenylphosphineoxide, such as, for example, IRGACURE 819 and 2-isopropyl-9H-thioxanthen-9-one, such as, for example, DAROCUR ITX (Ciba Specialty Chemicals).

The radiation curable phase change inks may also contain an amine synergist. An amine synergist is a co-initiator that donates a hydrogen atom to a photoinitiator and thereby forms a radical species that initiates polymerization (amine synergists can also consume oxygen dissolved in the ink—as oxygen inhibits free radical polymerization its consumption increases the speed of polymerization). Examples of the amine synergists may include ethyl-4-dimethylaminobenzoate and 2-ethylhexyl-4-dimethylaminobenzoate.

In other embodiments, the initiator can be a cationic initiator. Examples of suitable cationic photoinitiators may include aryldiazonium salts, diaryliodonium salts, triarysulfonium salts, triarylselenonium salts, dialkylphenacylsulfonium salts, triarylsulphoxonium salts and aryloxydiarylsulfonium salts.

Initiators that absorb radiation, for example UV light radiation, to initiate curing of the curable components of the ink may also be used. Examples of initiators absorb radiation at any desired or effective wavelength, for example, from about 200 to about 600 nanometers, from about 200 to about 500 nanometers, and from about 200 to about 420 nanometers. The total amount of initiator included in the ink maybe, for example, from about 0.5% to about 15%, and from about 1% to about 10%, by weight of the ink.

The radiation curable phase change inks can also optionally contain an antioxidant. The optional antioxidants can protect the images from oxidation and can also protect the ink components from oxidation during the heating portion of the ink preparation process. Specific examples of suitable antioxidant stabilizers may include, for example, NAUGARD 524, NAUGARD 635, NAUGARD A, NAUGARD L-403, and NAUGARD 959, commercially available from Crompton Corporation, IRGANOX 1010 and IRGASTAB UV 10, commercially available from Ciba Specialty Chemicals; GENORAD 16 and GENORAD 40 commercially available from Rahn A G, Zurich, Switzerland, and the like, as well as mixtures thereof. When present, the optional antioxidant is present in the ink in any desired or effective amount, for example from at least about 0.01 percent by weight of the ink carrier to about 20 percent by weight of the ink carrier, from about 0.1 percent by weight of the ink carrier to about 5 percent by weight of the ink carrier, and from about 1 percent by weight of the ink carrier to about 3 percent by weight of the ink carrier.

The radiation curable phase change inks can also contain additives to take advantage of the known functionality associated with such additives. Such additives may include, for example, defoamers, slip and leveling agents, pigment dispersants, and the like, as well as mixtures thereof. The inks can also include additional monomeric or polymeric materials as desired.

The phase change ink compositions generally have a jetting temperature from about 40° C. to 125° C., from about 50° C. to about 125° C., from about 60° C. to about 120° C., and from about 70° C. to about 110° C.

In one specific embodiment, the inks are jetted at low temperatures, such as temperatures below about 110° C., from about 40° C. to about 110° C., from about 50° C. to about 110° C., and from about 60° C. to about 90° C. At such low jetting temperatures, the temperature differential between the jetted ink and the flexographic plate upon which the ink is jetted can be used to rapidly effect a phase change in the ink (that is, from liquid to solid) due to the inclusion of the phase change agent. In particular, jetted ink droplets can be pinned into position on the printing plate through the action of a phase change transition in which the ink undergoes a significant viscosity change from a liquid state to a gel state (or semi-solid state) upon cooling for the gel point temperature from the jetting temperature.

In some embodiments, the gel point temperature at which the ink forms the gel state is any temperature below the jetting temperature of the ink, in one embodiment any temperature that is about 5° C. or more below the jetting temperature of the ink. In one embodiment, the gel state can be formed as the temperature drops to a temperature of at least about 25° C., and in another embodiment at a temperature of at least about 30° C., and in one embodiment of no more than about 100° C., in another embodiment of no more than about 70° C., and in yet another embodiment of no more than about 50° C., although the temperature can be outside of these ranges. A rapid and large increase in ink viscosity occurs upon cooling from the jetting temperature, at which the ink is in a liquid state, to the gel point temperature, at which the ink is in the gel state.

The phase change ink compositions can be prepared by any desired or suitable method. For example, the ink ingredients can be mixed together, followed by heating, to a temperature in one embodiment of from about 80° C. to about 120° C., and stirring until a homogeneous ink composition is obtained, followed by cooling the ink to ambient temperature, for example from about 20° C. to about 25° C. The inks are solid at ambient temperature.

The inks can be employed in an apparatus or a device for direct printing ink jet processes and in indirect (offset) printing ink jet applications. A direct printing process is also disclosed in, for example, U.S. Pat. No. 5,195,430, the disclosure of which is totally incorporated herein by reference. In embodiments, disclosed herein is directed to a process which comprises incorporating an ink as disclosed herein into an ink jet printing apparatus, melting the ink, forming a first ink layer by causing droplets of the melted ink to be ejected in an imagewise pattern onto a flexographic plate and gelling ink; forming additional ink layer on top of the first ink layer until a flexographic print master with a sufficient thickness is formed. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric elements. Inks as disclosed herein can also be employed in other hot melt printing processes, such as hot melt acoustic ink jet printing, hot melt continuous stream or deflection ink jet printing, and the like. Phase change inks as disclosed herein can also be used in printing processes other than hot melt ink jet printing processes.

Upon deposition onto the flexographic plate, the radiation curable phase change ink, which was ejected from the inkjet printhead as a liquid, solidifies into a gel on the flexographic plate. The phase transition allows for high image quality which can be achieved without the need for pinning.

Some radiation curable inks rely on free radical polymerization of the monomer in the ink. However, free radical polymerization is inhibited by the presence of oxygen. Specifically, there is a competition for free radicals between the rate of polymerization and the diffusion rate of oxygen; if oxygen can diffuse to the reactive radical faster than the radical can propagate through the polymer, little curing will take place. To increase the curing speed, such inks often require a curing zone that has greatly reduced oxygen content. The reduced oxygen content in the curing zone may be achieved by inerting the atmosphere with nitrogen. An inerted curing zone is not needed with phase change inks because unlike conventional UV curable inks, the increase in viscosity of the phase change inks reduces the rate of oxygen diffusion. Nitrogen inertion is thus required for the conventional UV inks to reduce the rate of oxygen diffusion to enable curing at high throughput. However the phase change ink increases in viscosity as a compact film on impingement onto the flexographic plate, reducing the rate of oxygen diffusion and its subsequent inhibition of radical cure. Thus, the phase change inks do not require nitrogen inertion to achieve high throughput curing.

Thus, printing on a flexographic plate may comprise providing and heating a radiation-curable phase change ink. Heating the phase change ink generally causes the ink to become liquid. The ink is then jetted from a printhead onto a flexographic plate one time to form the first layer of the pattern of the image. Upon deposition, each layer of the ink is cooled and gels on the surface of the flexographic plate (due to the difference in temperature), which causes a phase change back to a semi-solid gel. Each subsequent layer is jetted only after the previously jetted layer gels. This gelling may occur very rapidly, for example, in less than one second, so that the additional layers can be deposited directly on top of the first layer to form a printing master with a raised surface. The additional layers may be formed using a printhead to jet the ink for 1 to about 100 times, from about 5 to about 40 times, from about 10 to about 40 times and from about 20 to about 30 times, until a printing master with sufficient thickness is formed. The thickness of each layer in the printing master may have a thickness of at least one drop of the melted ink.

The thickness of the printing master may be from about 0.01 mm to about 100 mm, from about 0.05 mm to about 1 mm, from 0.1 mm to about 1 mm and from about 0.5 mm to about 1 mm. Finally, the ink is cured in the ambient atmosphere each layer of the printing master is formed.

The printing master with a raised surface can he formed into a three dimensional image, such as for example, a letter, a number or a symbol. The pattern for the printing master may have a straight edge or a tapered edge. Printing masters with straight edges are beneficial because straight edges typically allow for a higher resolution than a tapered edges. The tapered edge may formed using any of the masking techniques described in U.S. Pat. Nos. 6,790,598 and 6,294,317, the disclosures of each of which are incorporated herein by reference in their entirety. Furthermore, the tapered edge may also be formed by using an additional amount of ink on the layers closest to the flexographic plate and reducing the amount of ink accordingly as each layered is deposited on the subsequent layers.

The print head can be a full size head, which means that the printing head covers the entire surface of the plate support so that the head can remain stationary and rapidly jet at desired location on the flexographic plate material to build up layers at these locations. The print head may also be a smaller head that moves (translates) across the surface of the flexographic plate material or multiple small print heads stitched together to give fill width array. However, a smaller print head may require a precise control mechanism to accurately build up the layers at each desired location.

In embodiments, after a sufficient number of ink layers have been deposited on the flexographic plate, will the ink layers are cured. Thus, the single-step cure allows the printing master to be produced much quicker.

In embodiments, the printing master may also be produced by more than one curing step. For example, an initial portion of the printing master comprised of gelled layers may be formed on the flexographic plate. The initial portion represents at least 5% percent of the desired thickness for the printing master, such as, for example, from about 5% to about 60%, from about 10% to about 50% from about 15% to about 40% and from about 20% to about 35%, of the desired thickness of the printing master. After the initial portion of the printing master is cured, additional post-initial curing layers are deposited on top of the initial curing portion and gelled. Upon curing, these post-initial curing layers comprise the remaining thickness necessary to achieve the desired or sufficient thickness of the printing master. The printing master may also be produced by multiple additional deposition and curing steps.

Curing is defined when the curable compounds in the ink undergo an increase in molecular weight upon exposure to actinic radiation, such as crosslinking, chain lengthening, or the like that results in a hardening of the ink. Curing of the ink can be effected by exposure of the ink image to ultraviolet radiation or actinic radiation for any desired or effective period of time, such as, for example, from about 0.01 seconds to about 30 seconds, from about 0.01 seconds to about 15 seconds, and from about 0.01 seconds to about 5 seconds.

Actinic radiation sources encompass the ultraviolet and visible wavelength regions. The suitability of a particular actinic radiation source is governed by the photosensitivity of the initiator and the monomers used in preparing the flexographic printing masters. The preferred photosensitivity of most common flexographic printing masters are in the UV and deep UV area of the spectrum, as they afford better room-light stability. Examples of suitable visible and UV sources include carbon arcs, mercury-vapor arcs, fluorescent lamps, electron flash units, electron beam units, lasers, and photographic flood lamps. The most suitable sources of UV radiation are the mercury vapor lamps, particularly the sun lamps. Examples of industry standard radiation sources include the Sylvania 350 Blacklight fluorescent lamp (FR48T12/350 VL/VHO/180, 115 w), and the Philips UV-A “TL”-series low-pressure mercury-vapor fluorescent lamps. Typically, a mercury vapor arc or a sunlamp can be used at a distance of about 1.5 to about 60 inches (about 3.8 to about 153 cm) from the photopolymerizable layer. These radiation sources generally emit long-wave UV radiation between 310-400 nm. Flexographic printing masters sensitive to these particular UV sources use initiators that absorb between 310-400 nm.

Any ultraviolet light source may be employed as a radiation source, such as, for example, a high or low pressure mercury lamp, a cold cathode tube, a black light, an ultraviolet LED, an ultraviolet laser, and a flash light. Furthermore, the ultraviolet light source may be a radiation source that exhibits a relatively long wavelength UV-contribution having a dominant wavelength of 300-400 nm. Specifically, a UV-A (320 nm to 400 nm) light source may also be used due to the reduced light scattering therewith resulting in more efficient interior curing. However, UV-B (290 nm to 320 nm) or UV-C (100 nm to 290 nm) may also be used.

Furthermore, the printed image may be cured using two light sources of differing wavelength or illuminance. The use of two UV sources is advantageous due to the faster curing speed. For example, the first UV source can be selected to be rich in UV-A, UV-B, or UV-C and the second UV source, while different from the first light source, can then be selected to be rich in UV-A, UV-B or UV-C.

Examples of suitable materials for the support for the flexographic plate include transparent polymeric films such those formed by addition polymers and linear condensation polymers, transparent foams and fabrics. Under certain end-use conditions, metals such as steel, aluminum, copper and nickel, although not transparent, may also be used as a plate. The support may be in sheet form or in cylindrical form, such as a sleeve. The sleeve may be formed from single layer or multiple layers of flexible material, as for example disclosed by U.S. Patent Application Pub. No. 2002/0046668, incorporated herein by reference in its entirety. Flexible sleeves made of polymeric films or multiple layered sleeves, such as those described in U.S. Pat. No. 5,301,610, incorporated herein by reference in its entirety, may also be used. The sleeve may also be made of non-transparent, actinic radiation blocking materials, such as nickel or glass epoxy.

The support may have a thickness from 0.002 to 0.050 inch (0.0051 to 0.127 cm). A preferred thickness for the sheet form is 0.003 to 0.016 inch (0.0076 to 0.040 cm). The sleeve typically has a wall thickness from 10 to 80 mils (0.025 to 0.203 cm) or more. Preferred wall thickness for the cylinder form is 10 to 40 mils (0.025 to 0.10 cm).

Further, polymeric materials for the support may include plate comprised of cellulose acetate propionate, cellulose acetate butyrate, polyesters such as polyethylene terephthalate (PET) and polyethylene naphthalate (PEN); oriented polystyrene (OPS); oriented nylon (ONy); polypropylene (PP), oriented polypropylene (OPP); polyvinyl chloride (PVC); and various polyamides, polycarbonates, polyimides, polyolefins, poly(vinylacetals), polyethers and polysulfonamides, opaque white polyesters and extrusion blends of polyethylene terephthalate and polypropylene. Acrylic resins, phenol resins, glass and metals.

### EXAMPLES

### Example 1

### Colorless Ink

A solution is formed in a 600 mL beaker by adding (a) 400 g of SR9003 (dimer acrylate), (b) 27.5 g of SR399LV (pentafunctional acrylate) and (c) a mixture of photoinitiators comprised of 19.5 g of IRGACURE 127, 16.5 g of IRGACURE 379, 5.5 g of IRGACURE 819 and 11 g of DAROCURE ITX. The resulting solution is heated to 90° C., at which time 27.5 grams of UNILIN 350 (acrylate wax) and 41.25 g of a LV curable gellant are added to form a mixture. Upon stirring the mixture for 3 hours, the mixture is filtered to produce a colorless ink composition.

### Example 2

### Colored Ink

A solution is formed in a 600 mL beaker by adding (a) 400 g of SR9003 (dimer acrylate), (b) 27.5 g of SR399LV (pentafunctional acrylate) and (c) a mixture of photoinitiators comprised of 19.5 g of IRGACURE 127, 16.5 g of IRGACURE 379, 5.5 g of IRGACURE 819 and 11 g of DAROCURE ITX. The resulting solution is heated to 90° C., at which time 27.5 grams of UNILIN 350 acrylate wax and 41.25 g of a UV curable gellant are added to form a mixture. Upon stirring for 3 hours and subsequently filtering the mixture, 110 g of a 3% dispersion of cyan pigment is added at 90° C. and continuously heated at this temperature for 3 hours. The colored solution is then filtered to produce a cyan ink composition.

### Printing of Example 1

The ink is heated to a temperature greater than 80° C. to produce a melted ink. The melted ink is then placed in a printhead that is at a temperature greater than 80° C. The melted ink is then jetted onto a rigid polymer, wherein the gellant in the ink composition forms layers of a relief image. The relief image is then cured upon exposure to ultraviolet light. The cured relief image results in a three-dimensional structure with a thickness of from 300 μm that can be used as a flexographic printing master.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of forming a printing master on a flexographic plate, the method comprising:
(a) melting a radiation-curable phase change ink comprised of at least one curable monomer, at least one phase change agent, at least one photoinitiator and an optional colorant,
(b) depositing multiple layers of the melted ink at desired locations on the flexographic plate to form a raised pattern, wherein each deposited layer of ink is gelled prior to the deposition of a subsequent layer on the deposited layer, until the printing master with sufficient thickness is formed on the flexographic plate, and
(c) curing the ink on the flexographic plate upon the conclusion of the depositing step.

2. The method according to claim 1, wherein the phase change agent is a gellant.

3. The method according to claim 1, wherein the ink is cured by exposing the ink to ultraviolet radiation.

4. The method according to claim 1, wherein the viscosity of the melted ink is from about 10⁰ cP to about 10⁵ cP at a temperature of from about 60° C. to about 100° C.

5. The method according to claim 1, wherein the deposition of the ink for the deposited multiple layers occurs in a single pass of a printing device.

6. The method according to claim 1, wherein the thickness of the deposited multiple layers is from 0.01 mm to about 100 mm.

7. The method according to claim 1, wherein the melted ink is deposited by jetting the melted ink from a printing device for 1 to about 100 times to form the deposited multiple layers.

8. A method of forming a printing master on a flexographic plate, the method comprising:
(a) melting a radiation-curable phase change ink comprised of at least one curable monomer, at least one gellant, at least one photoinitiator and an optional colorant,
(b) depositing the melted ink on the flexographic plate in a pattern to form a layer of the pattern,
(c) allowing the deposited layer of the ink to gel on the flexographic plate,
(d) depositing the melted ink on the previous deposited layer to form an additional layer,
(e) allowing the deposited additional layer to gel,
(f) repeating steps (d) through (e) to form further additional deposited and gelled layers, until the printing master with sufficient thickness is formed on the flexographic plate, and
(g) curing the ink on the flexographic plate upon the achievement of the sufficient thickness,
wherein the viscosity of the melted ink is from about 10⁰ cP to about 10⁵ cP at a temperature of from about 60° C. to about 100° C.

9. The method according to claim 8, wherein the ink is cured by exposing the ink to ultraviolet radiation.

10. The method according to claim 8, wherein the deposition of the ink for the deposited layer occurs in a single pass of a printing device.

11. The method according to claim 8, wherein the deposition of the ink for the additional deposited layer and the further additional deposited layer occurs in a single pass of a printing device.

12. The method according to claim 8, wherein a total thickness of the deposited layer, the deposited additional layer and the further additional deposited layers is from 0.01 mm to about 100 mm.

13. The method according to claim 8, wherein the melted ink is deposited by jetting the melted ink from a printing device a single time to form deposited layer and the deposited additional layer.

14. The method according to claim 8, wherein the melted ink is deposited by jetting the melted ink from a printing device for 1 to about 100 times to form the further additional deposited layers.

15. A method of forming a printing master on a flexographic plate, the method comprising:
(a) melting a radiation-curable phase change ink comprised of at least one curable monomer, at least one phase change agent, at least one photoinitiator and an optional colorant,
(b) depositing the melted ink on the flexographic plate in a pattern to form a layer in the pattern,
(c) allowing the deposited layer of the ink to gel on the flexographic plate,
(d) depositing an additional layer of the melted ink on the previous deposited layer,
(e) allowing the deposited additional layer to gel,
(f) repeating steps (d) through (e) to form further additional deposited and gelled layers, until the printing master with an initial thickness is formed on the flexographic plate,
(g) curing the ink on the flexographic plate to form an initial portion of the printing master,
(h) depositing a post-initial curing layer of the melted ink on the initial portion of the printing master,
(i) allowing the deposited post-initial curing layer of the melted ink to gel on the flexographic plate,
(j) depositing an additional post-initial curing layer of the melted ink on the previous deposited post-initial curing layer,
(k) allowing the deposited additional post-initial curing layer to gel,
(l) repeating steps (j) through (k) to form further additional post-initial curing deposited and gelled layers, until the printing master with sufficient thickness is formed on the flexographic plate, and
(m) curing the ink on the flexographic plate upon the achievement of the sufficient thickness.

16. The method according to claim 15, wherein the initial thickness of the printing master is from about 5 to about 60 percent of the sufficient thickness.
